(19) United States
(12) Patent Application Publication
(10) Pub. No.: US 2026/0099544 A1
(43) Pub. Date: Apr. 9, 2026

(54) CROSS-DOMAIN LINK DETERMINATIONS THROUGH CELL FUSION AND SUPERGRAPH PROCESSING

(71) Applicant: Siemens Industry Software Inc., Plano, TX (US)

(72) Inventors: Arquimedes Martinez Canedo, Plainsboro, NJ (US); Rishabh Viswanathan, Cypress, CA (US)

(73) Assignee: Siemens Industry Software Inc., Plano, TX (US)

(21) Appl. No.: 19/112,507

(22) PCT Filed: Sep. 30, 2022
(86) PCT No.: PCT/US2022/077342

§ 371 Date: Mar. 17, 2025

(51) Int. Cl. G06F 16/901; G06F 16/22

(52) U.S. Cl. CPC G06F 16/9024; G06F 16/2272; G06F 16/2282

(57) ABSTRACT

A computing system (100) may include a database identification engine (108) configured to identify databases (111, 112) of different systems (121, 122). The computing system (100) may also include a link discovery engine (110) configured to construct a supergraph (220) that represents the data elements stored in the databases (111, 112), including by constructing graphs (211, 212) for tables in the databases (111, 112) and merging the graphs (211, 212) into the supergraph (220), including by performing a cell fusion to merge multiple nodes (311, 312) from the graphs (211, 212) with an identical data element value into a fused node (320) in the supergraph (220). The link discovery engine (110) also be configured to process the supergraph (220) according to cross-domain linking criteria to determine cross-domain links (410) for data stored in the databases (111, 112) of the different systems (121, 122).

### BACKGROUND

Computer systems can be used to create, use, and manage data for products, items, and other objects. Examples of computer systems include computer-aided design (CAD) systems (which may include computer-aided engineering (CAE) systems), visualization and manufacturing systems, product data management (PDM) systems, product lifecycle management (PLM) systems, and more. These systems may include components that facilitate the design, visualization, and simulated testing of product structures and product manufacture.

### BRIEF DESCRIPTION OF THE DRAWINGS

Certain examples are described in the following detailed description and in reference to the drawings.

FIG. 1 shows an example of a computing system that supports cross-domain link determinations through cell fusion and supergraph processing.

FIG. 2 shows an example of supergraph generation from databases of different systems according to the present disclosure.

FIG. 3 shows an example cell fusion process according to the present disclosure.

FIG. 4 shows an example determination of cross-domain links from supergraph processing according to the present disclosure.

FIG. 5 shows an example of logic that a system may implement to support cross-domain link determinations through cell fusion and supergraph processing.

FIG. 6 shows an example of a computing system that supports cross-domain link determinations through cell fusion and supergraph processing.

### DETAILED DESCRIPTION

As modern technological capabilities increase, the complexity and sheer amount of data generated by computing systems continue to increase as well. The explosion of data is prevalent nearly all facets of society and a multitude of industries, as modern design, testing, and manufacturing processes generate and consume increasing amounts of data. Even within a single project, design or product, multiple disparate systems can generate data for a common flow with common objects, but do so through distinct data schemas, data structures, naming conventions, properties, data constraints, and the like. As an illustrative example, PLM processes can utilize engineering systems that provide capabilities for mechanical design, electrical design, CAD, product simulation, and more. However, the applications that provide such capabilities often times operate independently, resulting in disparate data generation even when designing the same product. Integration and interoperability for data generated by disparate systems is a costly and time-consuming challenge facing modern computing systems.

Some conventional processes to link disparate data systems exist. One possible method to connect different datasets generated by different data systems is to use join operations on relational databases. Doing so can merge the data of two different tables into one, and attributes of stored data objects can be shown across both tables. Software applications can utilize inner or outer join operations to blend data, even for tables from disparate data sources and domains. However, join operations are limited in that they require explicit connections between the disparate data sets, like matching column names or matching keys that must be predetermined or otherwise specified. Oftentimes disparate systems (e.g., in PLM spaces) are developed separately and independently, so no such explicit connections exist between the various engineer systems. Finding meaningful and effective join columns from different tables of disparate data systems is many times left as a human-driven process that is time consuming, error prone, and tedious.

The disclosure herein may provide systems, methods, devices, and logic for cross-domain link determinations through cell fusion and supergraph processing. Cross-domain link determination technology described herein may provide capabilities to intelligently and efficiently determine links between dataset of different systems, also referred to herein as cross-domain links. Such cross-domain links may refer to or include connections between specific cells, columns, tables, or other data elements between differing datasets, such as data in disparate datasets that refer to the same object or data entity. As described herein, cross-domain link determination technology of the present disclosure may leverage graph analytics, object vector embedding, or a combination of both. For example, individual graphs can be constructed from different databases, and the individual graphs can be merged to form a supergraph. Graph merging to form supergraphs may include cell fusion processes to merge multiple nodes from the graphs with an identical data element value into a single fused node in the supergraph. Cell fusion may allow for consideration and analysis of identical data values from different graphs (and thus different tables) regardless of the schema, naming convention, or other constraints set for such data element values. Thus, data elements from differing table columns can be linked together in a fused node allowing for increased effectiveness in graph processing techniques to determine links between datasets of disparate systems.

Additionally or alternatively, the cross-domain link determination technology of the present disclosure may support processing of supergraphs to determine cross-domain links in disparate datasets. Extraction of features of a supergraph that represents data from multiple systems can be performed in various ways, e.g., through community detection processes, clustering processes, centrality analyses, and more. Determination of cross-domain links through such graph analytics may be controlled through cross-domain linking criteria that can specify a threshold value to exceed for the community detection processes, clustering processes, centrality analyses, etc. As yet another feature, vector embedding can be utilized in order to analyze the datasets from different systems, whether in combination with graph processing (e.g., to represent node or edge values in a vector format for comparison) or through vector representations directly on data elements of the different systems.

Through the cross-domain link determination technology described herein, determinations of connections between disparate datasets can be performed with increased precision, accuracy, and efficiency. These and other cross-domain link determination features and technical benefits are described in greater detail herein.

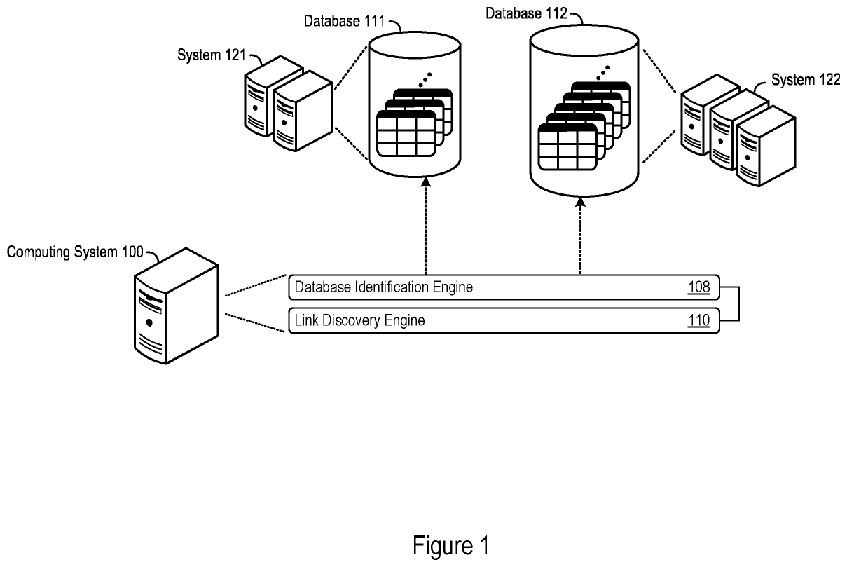

FIG. 1 shows an example of a computing system 100 that supports cross-domain link determinations through cell fusion and supergraph processing. The computing system 100 may take the form of a single or multiple computing devices such as application servers, compute nodes, desktop or laptop computers, smart phones or other mobile devices, tablet devices, embedded controllers, and more. In some implementations, the computing system 100 hosts, supports, executes, or implements a data analysis system to process, analyze, consume, validate, or otherwise use data from different systems.

As an example implementation to support any combination of the cross-domain link determination features described herein, the computing system 100 shown in FIG. 1 includes a database identification engine 108 and a link discovery engine 110. The computing system 100 may implement the engines 108 and 110 (including components thereof) in various ways, for example as hardware and programming. The programming for the engines 108 and 110 may take the form of processor-executable instructions stored on a non-transitory machine-readable storage medium and the hardware for the engines 108 and 110 may include a processor to execute those instructions. A processor may take the form of single processor or multi-processor systems, and in some examples, the computing system 100 implements multiple engines using the same computing system features or hardware components (e.g., a common processor or a common storage medium).

In operation, the database identification engine 108 may identify databases of different systems, such as the databases 111 and 112 of the different systems 121 and 122 shown in FIG. 1. The databases 111 and 112 may comprise tables comprised of data elements stored in rows and columns, and may be disparate or independent from one another in that the databases 111 and 112 do not share a common schema, format, or other structural organization. In operation, the link discovery engine 110 may construct a supergraph that represents the data elements stored in the databases 111 and 112 of the different systems 121 and 122. The link discovery engine 110 may do so by constructing graphs for the tables in the databases 111 and 112 of the different systems 121 and 122 in which data elements of the tables are represented as nodes in the graphs and merging the graphs constructed from the databases 111 and 112 of the different systems 121 and 122 into the supergraph, including by performing a cell fusion to merge multiple nodes from the graphs with an identical data element value into a fused node in the supergraph. In operation, the link discovery engine 110 may also process the supergraph according to cross-domain linking criteria to determine cross-domain links for data stored in the databases 111 and 112 of the different systems 121 and 122.

These and other cross-domain link determination features and technical benefits are described in greater detail next.

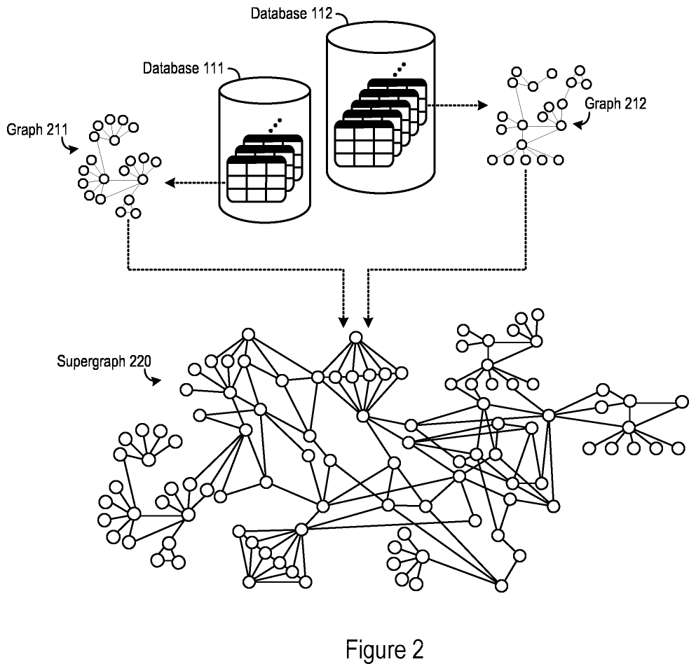

FIG. 2 shows an example of supergraph generation from databases of different systems according to the present disclosure. In the example of FIG. 2, the database identification engine 108 may identify the databases 111 and 112 of the different systems 121 and 122, doing so in any number of ways. For example, the databases 111 and 112 may be selected by an application user for which to determine cross-domain links. As another example, the databases 111 and 112 may be part of a predetermined dataset configured by a system administrator or other entity for which to discover cross-domain links (e.g., regularly on a specified schedule, on-demand, responsive to any suitable determination timing criteria being met, or any combination thereof).

The database 111 and the database 112 may be part of disparate systems 121 and 122, each with schemas, data storage formats, or constraints specified independently from one another. While the systems 121 and 122 may be disparate from one another, the databases 111 and 112 may store datasets for common data entities or object (e.g., PLM product, design flow, or other inter-related process). As a continuing example, the database 111 may store mechanical design data for a product (e.g., an airplane design) and the database may store electrical design data for the product. Thus, the databases 111 and 112 may store data that represent the same logical element in the product, but do so through disparate and independent schemas, tables, column names, formats, and the like.

The cross-domain link determination technology of the present disclosure may support determination of cross-domain links between the datasets (e.g., tables) stored in the databases 111 and 112. To do so, the link discovery engine 110 may convert data stored in tabular formats (e.g., in relational databases) into a graph format. To do so, the link discovery engine 110 may convert tables stored in both the databases 111 and 112 into graphs in which data elements (e.g., cells) in the tables of the databases 111 and 112 are represented as nodes. Thus, a node value of a node of a constructed graph may be specified as the data element value (e.g., value of a table cell) of the data element for which the node is created. In constructing the graphs, edges may be inserted by the link discovery engine 110 based on nodes representing data elements in shared rows, and in any of the ways described herein. The link discovery engine 110 may construct a separate or individual graph for each individual table in the databases 111 and 112. In the example shown in FIG. 2, the link discovery engine 110 constructs the graph 211 for a particular table in the database 111 and constructs the graph 212 for a different table in the database 112.

In some implementations, the link discovery engine 110 may construct a graph for a particular table by converting each cell in the particular table into a graph node and inserting edges into the graph at each node for every other node that represents a cell in a same row of the table as that node. Thus, constructing graphs for the tables in the databases 111 and 112 may comprise creating a given graph for a given table by creating a node for each unique data element in the given individual table and creating edges between nodes of all data elements in a same row of the given individual table. In this example implementation, every data element in a table will have a graph node that is linked by an edge to the graph nodes for every other data element that is the same row of the table.

As another implementation, the link discovery engine 110 may construct a graph for a particular table by converting each cell in the particular table into a graph node and inserting edges into the graph at each node that is a key data element for the particular table. Key data elements may refer to values of a table that are part of a key for the table (e.g., a primary key or foreign key). Thus, data elements in a column that is a key for the table may be referred to as key data elements for the table. In this implementation, the link discovery engine 110 may construct a graph for a given table by creating a node for each unique data element in the given table and creating edges between a node of a key data element in the given table and nodes of other data elements in a same row as the key data element, and the link discovery engine 110 may so without creating edges between the nodes of the other data elements even though the other data elements are also in the same row with one another (and with the key data element).

In any such manner as described herein, the link discovery engine 110 may construct graphs for tables of disparate databases. As graphs do not require explicit links to merge, the link discovery engine 110 may merge the various graphs constructed for the tables of the databases 111 and 112 to form a supergraph 220. As used herein, a supergraph may refer to any graph merged from multiple individual graphs constructed from tables of different (e.g., disparate or independent) databases. The link discovery engine 110 constructs the supergraph 220 shown in FIG. 2 to represent a dataset comprised of data from disparate systems 121 and 122.

Note that nodes from different tables may not share edges if edges are only inserted between nodes for data elements in the same row. This may occur because for data elements to be in a same table row, the data elements will be in the same table (and thus the same individual graph). Without any edges that link nodes of the different graphs (generated from individual tables), a merged supergraph may merely take the form of multiple individual graphs represented in a single graph structure. This single graph structure of merged individual graphs may be without links (e.g., edges) that connect the multiple individual graphs, and thus the supergraph representation may include only disparate, unlinked data representations of tables from disparate databases.

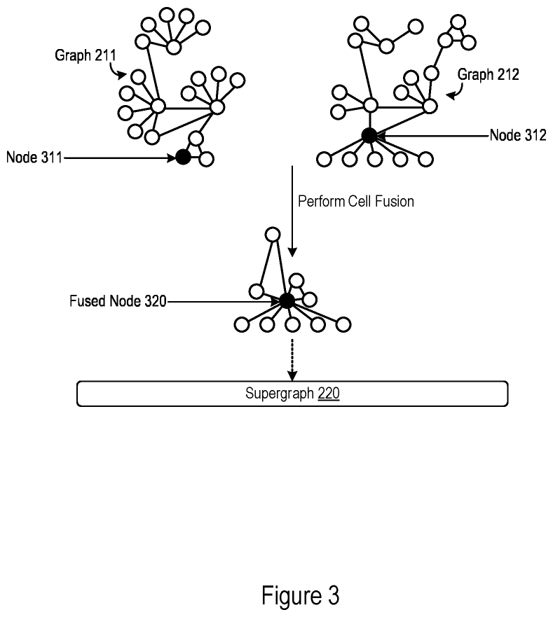

To link data (e.g., nodes) from different tables and different databases, the link discovery engine 110 may utilize cell fusion processes in constructing the supergraph 220 to represent the data of the databases 111 and 112. A cell fusion process may refer to the combining of multiple nodes into a single node, referred to herein as a fused node. The multiple nodes merged into the fused node may be from the same table (and thus same individual graph) or different tables (and thus different graphs). By fusing nodes from different graphs (and thus different tables, including tables from different databases), the link discovery engine 110 may link data from different, disparate data sources such as the databases 111 and 112. In some implementations, the link discovery engine 110 may perform a cell fusion process by merging multiple nodes from graphs with an identical data element value into a fused node. Example features for cell fusion processes are described next with reference to FIG. 3.

FIG. 3 shows an example cell fusion process according to the present disclosure. The link discovery engine 110 may perform any of the cell fusion techniques described herein, for example doing so as part of forming a supergraph to represent data from disparate systems. As an example shown through FIG. 3, the link discovery engine 110 may perform a cell fusion process for nodes of the graphs 211 and 212 described in FIG. 2, which may respectively represent tables from different databases 111 and 112 of different systems 121 and 122.

To perform a cell fusion process, the link discovery engine 110 may identify any nodes of any number of graphs with the same (e.g., identical) data element value. To explain further through FIG. 3, the graph 211 may represent a table of the database 111 that stores mechanical design data of an airplane design. The graph 212 may represent a table of the database 112 that stores electrical design data of the airplane design. The link discovery engine 110 may parse the graphs 211 and 212 and determine that node 311 of the graph 211 and node 312 of the graph 212 have the same data element value. For example, the nodes 311 and node 312 may have an identical string data element value (e.g., “Wire₁₂₃”), a same unitless numerical data element value (e.g., “1431”), a same numerical data element value with units (e.g., “35.3 millimeters”), or any other data element values that the link discovery engine 110 determines as equal, identical, or otherwise equivalent.

Responsive to a determination of nodes with identical (e.g., equal or the same) data element values, the link discovery engine 110 may fuse the determined nodes into a single fused node. In the example of FIG. 3, the link discovery engine 110 may fuse (e.g., merge) the nodes 311 and 312 into the fused node 320 shown in FIG. 3. To do so, the link discovery engine 110 may represent the fused node 320 as a single node in a graph (e.g., the supergraph 220) but include all of the edges to other nodes in the graphs 211 and 212 that link to the nodes 311 and 312 that are fused together. In that regard, the fused node 320 may have edges that link to nodes in both the graph 211 (that is, the nodes of the graph 211 linked to the node 311) and the graph 212 (that is, the nodes of the graph 212 linked to the node 312). Thus, the cell fusion process performed by the link discovery engine 110 may insert, create, or generate a fused node 320 in the supergraph 220 that has edges to nodes of both the graph 211 and 212 (and thus linking nodes from disparate graphs together).

Through cell fusion processes, the link discovery engine 110 may correlate data elements from different tables and different databases irrespective of a schema or structure used for the different databases. In that regard, the link discovery engine 110 may fuse nodes from data elements in columns of different names and schemas, allowing for correlation and linking of datasets even when no explicit or schema-based link exists. As an illustrative example to explain the benefits of cell fusions, the database 111 storing mechanical design data for an airplane design may include the following table:

| Route | Length |
|---|---|
| Wire₁₂₃ | 5 |
| Wire₄₅₆ | 7 |
| Wire₀₀₀ | 12 |

Continuing this illustrative example, the database 112 storing electrical design data for the airplane design may include the following table:

| Wire Name | Layer |
|---|---|
| Wire₁₂₃ | A |
| Wire₄₅₆ | B |
| Wire₀₀₀ | C |

In this illustrative example, mechanical and electrical engineers may utilize common wire names for the airplane design, e.g., through passing of design iterations amongst teams. However, due to independent schemas used by the databases 111 and 112 as part of distinct and independent mechanical and electrical software applications, the columns identifying the same wires in the airplane design are configured differently in the databases 111 and 112 as a “Route” column and a “Wire Name” column respectively. A join operation would not be sufficient to link these two columns because of the different naming structure (and thus lack of an explicit or express connection between the columns).

However, cell fusion by the link discovery engine 110 can correlate the data stored in these tables from different databases. Even though the table columns are named differently in the databases 111 and 112, the link discovery engine 110 may nonetheless fuse nodes for “Wire₁₂₃”, “Wire₄₅₆”, and “Wire₀₀₀” because the data element values (e.g., the cell values) in these different tables are the same.

FIG. 3 shows but an example of fusing two nodes (nodes 311 and 312 from graphs 211 and 212) into the fused node 320. However, the link discovery engine 110 may merge any number of nodes that share a data element value into a single fused node. For instance, the link discovery engine 110 may merge any number of other nodes from other tables constructed from the databases 111 and 112 that also have a node value of “Wire₁₂₃” into a single fused node, and the fused node may thus share edges to any other nodes (e.g., from other individual graphs) linked to such other nodes merged into the fused node.

According to the cross-domain link determination technology of the present disclosure, cell fusion processes may be performed for some or all of the nodes that share node values with other nodes in constructed graphs. In some implementations, the link discovery engine 110 may perform cell fusion for every node that shares a node value with another node in the constructed graphs. As such, the link discovery engine 110 may perform cell fusion for both key data elements and non-key data elements in database tables with an identical data element value.

In other implementations, the link discovery engine 110 may perform cell fusion for some, but not all, nodes that share a node value with another node in the constructed graphs. Such selective cell fusion may be based on any number of factors, criteria, or constraints, for example differentiating between key data elements and non-key data elements. In some examples, the link discovery engine 110 may perform cell fusion for key data elements in the tables with an identical data element value, but not for non-key data elements even though the non-key data elements have an identical data element value as other data elements in the tables.

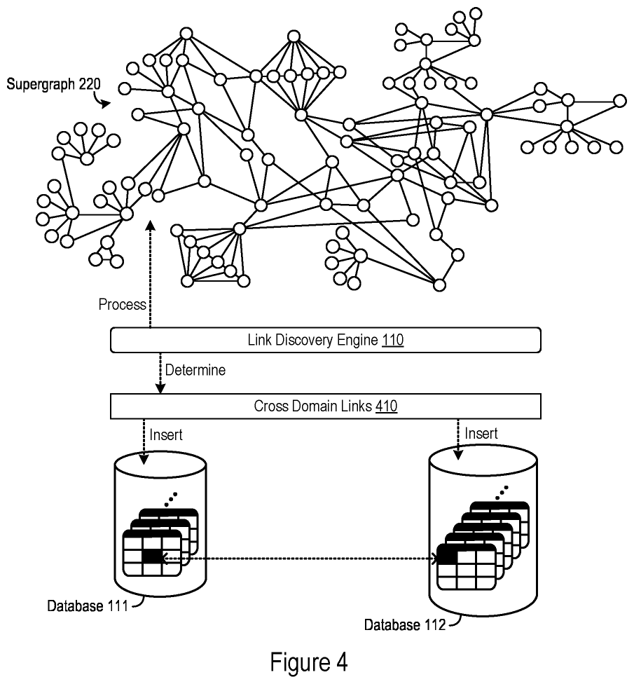

In any of the ways described herein, the link discovery engine 110 may construct supergraphs representing datasets of multiple different systems. Through cell fusion techniques of the present disclosure, the constructed supergraph may include links (e.g., edges) between data elements of disparate tables and databases, which can support cross-domain link determinations with increased effectiveness. Example features of cross-domain link determinations through supergraph processing are described in greater detail next, including with reference to FIG. 4.

FIG. 4 shows an example determination of cross-domain links from supergraph processing according to the present disclosure. As a supergraph may represent datasets from disparate databases and systems in a single graphical format, analysis of the supergraph may be performed to determine cross domain links for the datasets. The link discovery engine 110 may process supergraphs in any suitable manner and according to any suitable criteria, referred to herein as cross-domain linking criteria. Cross-domain linking criteria may be configurable and specify any suitable criteria by which to determine cross-domain links from supergraph processing.

The link discovery engine 110 may process supergraphs using any suitable graph analytics techniques and the cross-domain linking criteria may be specified based on the used graph analytics techniques. In FIG. 4, the link discovery engine 110 processes the supergraph 220 to determine cross domain links 410 for data stored in the databases 111 and 112. As examples, the link discovery engine 110 may process supergraph 220 by performing a community detection process, a clustering process, or a centrality analysis on the supergraph 220. In such examples, the cross-domain linking criteria may specify a threshold value to exceed for the community detection process, the clustering process, or the centrality analysis to determine the cross-domain links in the data.

Community detection processes performed by the link discovery engine 110 may include any algorithms, techniques, or processing to identify node networks within a graph that are densely connected internally. Such density determinations may be configured as thresholds set in specific community detection algorithms and the cross-domain linking criteria may specify a threshold density or community overlap for determination of cross-domain links between graph nodes (and thus data elements) from different databases. The link discovery engine 110 may implement or perform any suitable community detection algorithm and configure any community-related cross-domain linking criteria to determine cross-domain links through supergraph processing. In some implementations, the link discovery engine 110 may determine cross-domain links for any nodes (and thus data elements from tables) detected to be in the same graph community and from different databases or disparate datasets.

Additionally or alternatively, the link discovery engine 110 may process the supergraph 220 through a clustering process to determine cross-domain links 410. In doing so, the link discovery engine 110 may support, implement, or perform any type of graph clustering algorithm in order to process supergraphs. In a similar manner as community detection, clustering may provide a graphical analysis technique by which to extract features of datasets represented by supergraphs. Nodes from different databases determined to be in the same cluster may be one example of cross-domain linking criteria by which to determine cross-domain links from supergraph processing.

As yet another example, the link discovery engine 110 may process the supergraph 220 to determine cross-domain links 410 through performing centrality analyses on the supergraph 220. Centrality values computed through such processes may provide a measure of a importance level for information flow through in a graphical network, and importance can be defined in various ways according to various centrality algorithms. As example measures of importance, the link discovery engine 110 may weight centrality based on (e.g., as a function of or proportional to) a number of direct connections (e.g., edges) to other nodes, a measure of transitive connection to selected other nodes in the supergraph, number of nodes that a given node can be reach with a threshold number of hops, the number of shortest paths that a given node is part of to traverse selected portions of the graph (e.g., node pairs), and the like. Nodes with high centrality measures (e.g., exceeding a threshold value) may be identified as cross-domain links, e.g., fused nodes with cell fusions from multiple different databases.

As yet another example of processing, the link discovery engine 110 may utilize vector embeddings to process a supergraph or otherwise determine cross-domain links between disparate datasets. The link discovery engine 110 may generate vector embeddings for data elements of tables (e.g., nodes in constructed graphs or in supergraphs), for example as real-valued vector representations. Vector representations of node values/data element values of tables can be used since many time raw data element values can not be quantitatively compared with other data element types, but vector representations can. As such, data element values that are similar to one another (e.g., in format, value, topology, structure, data type) will be closer in the vector space than others that differ.

The link discovery engine 110 may generate embedded vector representations for the nodes of a supergraph and perform a quantitative comparison in the vector space. For nodes from different databases or disparate datasets that within a threshold range in the vector space, the link discovery engine 110 may determine a cross-domain exist to exist between such nodes. For nodes with vector representations that differ outside the threshold range, the link discovery engine 110 may determine that no cross-domain link exists between such nodes.

Note that the link discovery engine 110 need not use graph processing to compare different datasets via vector embedding. In some implementations, the link discovery engine 110 may embed data elements directly from tabular formats, e.g., through individual cell embeddings or column embeddings. For individual cells, the link discovery engine 110 may represent each cell value for tables of multiples databases as a vector and compare vector representations to determine cross-domain links between table cells of different databases (e.g., within a certain distance in the vector space).

Additionally or alternatively, the link discovery engine 110 may embed table columns as vector representations. To do so, the link discovery engine 110 may generate a column vector value as a function of the cell vector values of that column. As one example, the link discovery engine 110 may compute a column vector value as an average of the cell vectors of that column. Then, the link discovery engine 110 can compare column vector values from columns of multiple tables and disparate datasets, allowing for determination of cross-domain links for columns from disparate datasets within a threshold distance in the vector space. As such, the link discovery engine 110 may quantitively compare different cells, columns, nodes, etc. through vector embedding models and techniques.

As yet another example of processing, the link discovery engine 110 may apply geometric reasoning to represent nodes with data element values that are closer in physical proximity as closer in a graph. For example, the link discovery engine 110 may extract location data (e.g., latitudinal and/or longitudinal coordinates) and represent such distances and locations in graphs, for example through node values (e.g., coordinates), edge values (e.g., distance), and such. As an illustrative example, PLM datasets may store care manufacturer data from various locations across a country or the world. Factory data that is closer in geographical proximity to one another may be represented as such in a constructed supergraph, allowing for processing and cross-domain linking criteria that can be specified based on physical distances.

In any of the various ways described herein, the link discovery engine 110 may process supergraphs to determine cross-domain links in disparate datasets. In some implementations, the link discovery engine 110 may provide the determined cross-discovery links for further validation, e.g., by application users or experts to expressly validate determined cross-domain links via the cross-domain link determination technology of the present disclosure. In some implementations, the link discovery engine 110 may insert the determined cross-domain links into one or more of the databases of the different systems. In FIG. 4, the link discovery engine 110 inserts the cross-domain links 410 into the databases 111 and 112, for example through performing a join operation on determined cross-domain links, expressly setting a linked flag, or providing any suitable link, flag, or trace between multiple data elements stored in the databases 111 and 112 or the systems 121 and 122.

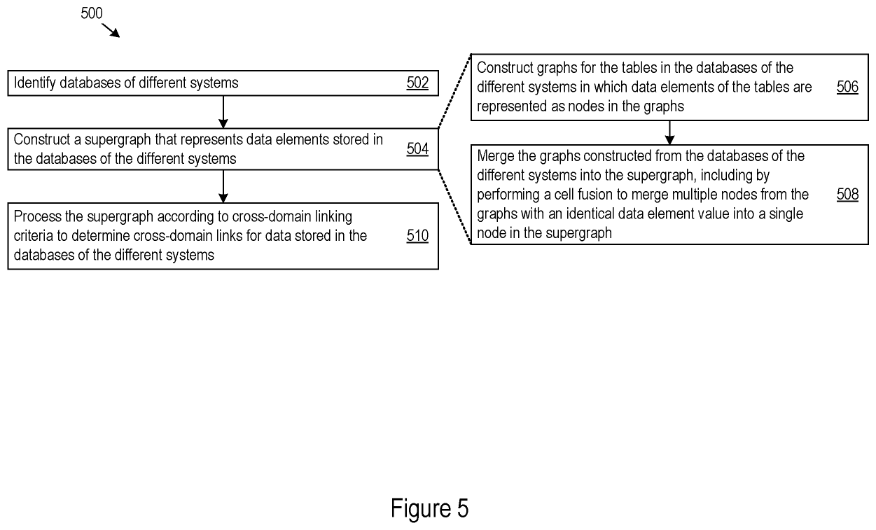

FIG. 5 shows an example of logic 500 that a system may implement to support cross-domain link determinations through cell fusion and supergraph processing. For example, the computing system 100 may implement the logic 500 as hardware, executable instructions stored on a machine-readable medium, or as a combination of both. The computing system 100 may implement the logic 500 via the database identification engine 108 and the link discovery engine 110, through which the computing system 100 may perform or execute the logic 500 as a method to support cross-domain link determinations. The following description of the logic 500 is provided using the database identification engine 108 and the link discovery engine 110 as examples. However, various other implementation options by computing systems are possible.

In implementing the logic 500, the database identification engine 108 may identify databases of different systems (502), for example as described through identification of the databases 111 and 121 of the different systems 121 and 122 presented herein. In implementing the logic 500, the link discovery engine 110 may construct a supergraph that represents the data elements stored in the databases of the different systems (504), for example doing so by constructing graphs for the tables in the databases of the different systems in which data elements of the tables are represented as nodes in the graphs (506) and merging the graphs constructed from the databases of the different systems into the supergraph, including by performing a cell fusion to merge multiple nodes from the graphs with an identical data element value into a fused node in the supergraph (508). In implementing the logic 500, the link discovery engine 110 further may process the supergraph according to cross-domain linking criteria to determine cross-domain links for data stored in the databases of the different systems (510), doing so in any of the ways described herein.

The logic 500 shown in FIG. 5 provides an illustrative example by which a computing system 100 may support cross-domain link determinations through cell fusion and supergraph processing. Additional or alternative steps in the logic 500 are contemplated herein, including according to any of the various features described herein for the database identification engine 108, the link discovery engine 110, or any combinations thereof.

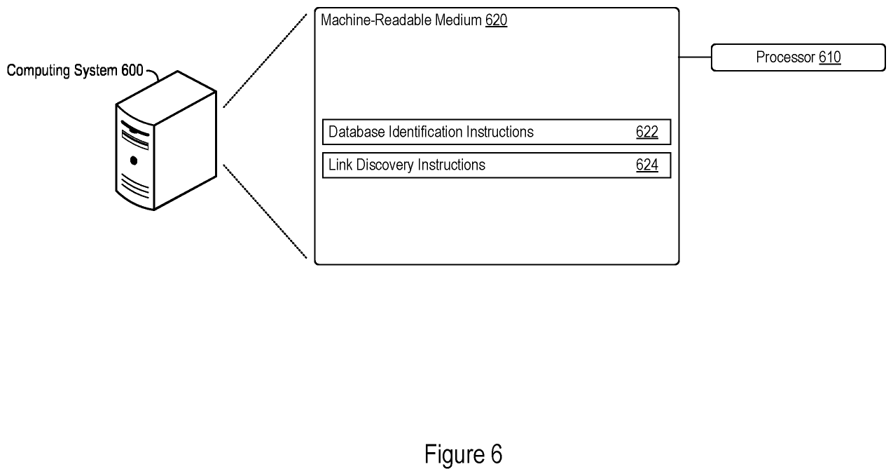

FIG. 6 shows an example of a computing system 600 that supports cross-domain link determinations through cell fusion and supergraph processing. The computing system 600 may include a processor 610, which may take the form of a single or multiple processors. The processor(s) 610 may include a central processing unit (CPU), microprocessor, or any hardware device suitable for executing instructions stored on a machine-readable medium. The computing system 600 may include a machine-readable medium 620. The machine-readable medium 620 may take the form of any non-transitory electronic, magnetic, optical, or other physical storage device that stores executable instructions, such as the database identification instructions 622 and the link discovery instructions 624 shown in FIG. 6. As such, the machine-readable medium 620 may be, for example, Random Access Memory (RAM) such as a dynamic RAM (DRAM), flash memory, spin-transfer torque memory, an Electrically-Erasable Programmable Read-Only Memory (EEPROM), a storage drive, an optical disk, and the like.

The computing system 600 may execute instructions stored on the machine-readable medium 620 through the processor 610. Executing the instructions (e.g., the database identification instructions 622 and/or the link discovery instructions 624) may cause the computing system 600 to perform any of the cross-domain link determination features described herein, including according to any of the features of the database identification engine 108, the link discovery engine 110, or combinations of both.

For example, execution of the database identification instructions 622 by the processor 610 may cause the computing system 600 to may identify databases of different systems (such as the databases 111 and 112 of the different systems 121 and 122). Execution of the link discovery instructions 624 by the processor 610 may cause the computing system 600 to construct a supergraph that represents the data elements stored in the databases of the different systems, doing so by constructing graphs for the tables in the databases of the different systems in which data elements of the tables are represented as nodes in the graphs and merging the graphs constructed from the databases of the different systems into the supergraph, including by performing a cell fusion to merge multiple nodes from the graphs with an identical data element value into a fused node in the supergraph. Execution of the link discovery instructions 624 by the processor 610 may further cause the computing system 600 to process the supergraph according to cross-domain linking criteria to determine cross-domain links for data stored in the databases of the different systems.

Any additional or alternative cross-domain link determination features as described herein may be implemented via the database identification instructions 622, link discovery instructions 624, or a combination of both.

The systems, methods, devices, and logic described above, including the database identification engine 108 and the link discovery engine 110, may be implemented in many different ways in many different combinations of hardware, logic, circuitry, and executable instructions stored on a machine-readable medium. For example, the database identification engine 108, the link discovery engine 110, or combinations thereof, may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. A product, such as a computer program product, may include a storage medium and machine-readable instructions stored on the medium, which when executed in an endpoint, computer system, or other device, cause the device to perform operations according to any of the description above, including according to any features of the database identification engine 108, the link discovery engine 110, or combinations thereof.

The processing capability of the systems, devices, and engines described herein, including the database identification engine 108 and the link discovery engine 110, may be distributed among multiple system components, such as among multiple processors and memories, optionally including multiple distributed processing systems or cloud/network elements. Parameters, databases, and other data structures may be separately stored and managed, may be incorporated into a single memory or database, may be logically and physically organized in many different ways, and may be implemented in many ways, including data structures such as linked lists, hash tables, or implicit storage mechanisms. Programs may be parts (e.g., subroutines) of a single program, separate programs, distributed across several memories and processors, or implemented in many different ways, such as in a library (e.g., a shared library).

While various examples have been described above, many more implementations are possible.

1. A method comprising:
by a computing system:
identifying databases of different systems, wherein the databases comprise tables comprised of data elements stored in rows and columns;
constructing a supergraph that represents the data elements stored in the databases of the different systems, including by:
constructing graphs for the tables in the databases of the different systems in which data elements of the tables are represented as nodes in the graphs; and
merging the graphs constructed from the databases of the different systems into the supergraph, including by performing a cell fusion to merge multiple nodes from the graphs with an identical data element value into a fused node in the supergraph; and
processing the supergraph according to cross-domain linking criteria to determine cross-domain links for data stored in the databases of the different systems.

2. The method of claim 1, wherein constructing the graphs for the tables in the databases of the different systems comprises creating a given graph for a given table by:
creating a node for each unique data element in the given individual table; and
creating edges between nodes of all data elements in a same row of the given individual table.

3. The method of claim 1, wherein constructing the graphs for the tables in the databases of the different systems comprises creating a given graph for a given table by:
creating a node for each unique data element in the given table; and
creating edges between a node of a key data element in the given table and nodes of other data elements in a same row as the key data element, and doing so without creating edges between the nodes of the other data elements even though the other data elements are also in the same row with one another.

4. The method of claim 1, comprising performing the cell fusion for both key data elements and non-key data elements in the tables with an identical data element value.

5. The method of claim 1, comprising performing the cell fusion for key data elements in the tables with an identical data element value, but not for non-key data elements even though the non-key data elements have an identical data element value as other data elements in the tables.

6. The method of claim 1, wherein processing the supergraph comprises performing a community detection process, a clustering process, or a centrality analysis on the supergraph, and
wherein the cross-domain linking criteria specifies a threshold value to exceed for the community detection process, the clustering process, or the centrality analysis to determine the cross-domain links in the data.

7. The method of claim 1, further comprising inserting the determined cross-domain links into one or more of the databases of the different systems.

8. A system comprising:
a processor; and
a non-transitory machine-readable medium comprising instructions that, when executed by the processor, cause a computing system to:
identify databases of different systems, wherein the databases comprise tables comprised of data elements stored in rows and columns;
construct a supergraph that represents the data elements stored in the databases of the different systems, including by:
constructing graphs for the tables in the databases of the different systems in which data elements of the tables are represented as nodes in the graphs; and
merging the graphs constructed from the databases of the different systems into the supergraph, including by performing a cell fusion to merge multiple nodes from the graphs with an identical data element value into a fused node in the supergraph; and
process the supergraph according to cross-domain linking criteria to determine cross-domain links for data stored in the databases of the different systems.

9. The system of claim 8, wherein the instructions, when executed, cause the computing system to construct the graphs for the tables in the databases of the different systems by creating a given graph for a given table, including by:
creating a node for each unique data element in the given individual table; and
creating edges between nodes of all data elements in a same row of the given individual table.

10. The system of claim 8, wherein the instructions, when executed, cause the computing system to construct the graphs for the tables in the databases of the different systems by creating a given graph for a given table, including by:
creating a node for each unique data element in the given table; and
creating edges between a node of a key data element in the given table and nodes of other data elements in a same row as the key data element, and doing so without creating edges between the nodes of the other data elements even though the other data elements are also in the same row with one another.

11. The system of claim 8, wherein the instructions, when executed, cause the computing system to perform the cell fusion for both key data elements and non-key data elements in the tables with an identical data element value.

12. The system of claim 8, wherein the instructions, when executed, cause the computing system to perform the cell fusion for key data elements in the tables with an identical data element value, but not for non-key data elements even though the non-key data elements have an identical data element value as other data elements in the tables.

13. The system of claim 8, wherein the instructions, when executed, cause the computing system to process the supergraph by performing a community detection process, a clustering process, or a centrality analysis on the supergraph, and
wherein the cross-domain linking criteria specifies a threshold value to exceed for the community detection process, the clustering process, or the centrality analysis to determine the cross-domain links in the data.

14. The system of claim 8, wherein the instructions, when executed, further cause the computing system to insert the determined cross-domain links into one or more of the databases of the different systems.

15. A non-transitory machine-readable medium comprising instructions that, when executed by a processor, cause a computing system to;
identify databases of different systems, wherein the databases comprise tables comprised of data elements stored in rows and columns;
construct a supergraph that represents the data elements stored in the databases of the different systems, including by:
constructing graphs for the tables in the databases of the different systems in which data elements of the tables are represented as nodes in the graphs; and
merging the graphs constructed from the databases of the different systems into the supergraph, including by performing a cell fusion to merge multiple nodes from the graphs with an identical data element value into a fused node in the supergraph; and
process the supergraph according to cross-domain linking criteria to determine cross-domain links for data stored in the databases of the different systems.

16. The non-transitory machine-readable medium of claim 15, wherein the instructions, when executed, cause the computing system to construct the graphs for the tables in the databases of the different systems by creating a given graph for a given table, including by:
creating a node for each unique data element in the given individual table; and
creating edges between nodes of all data elements in a same row of the given individual table.

17. The non-transitory machine-readable medium of claim 15, wherein the instructions, when executed, cause the computing system to construct the graphs for the tables in the databases of the different systems by creating a given graph for a given table, including by:
creating a node for each unique data element in the given table; and
creating edges between a node of a key data element in the given table and nodes of other data elements in a same row as the key data element, and doing so without creating edges between the nodes of the other data elements even though the other data elements are also in the same row with one another.

18. The non-transitory machine-readable medium of claim 15, wherein the instructions, when executed, cause the computing system to perform the cell fusion for key data elements in the tables with an identical data element value, but not for non-key data elements even though the non-key data elements have an identical data element value as other data elements in the tables.

19. The non-transitory machine-readable medium of claim 15, wherein the instructions, when executed, cause the computing system to process the supergraph by performing a community detection process, a clustering process, or a centrality analysis on the supergraph, and
wherein the cross-domain linking criteria specifies a threshold value to exceed for the community detection process, the clustering process, or the centrality analysis to determine the cross-domain links in the data.

20. The non-transitory machine-readable medium of claim 15, wherein the instructions, when executed, further cause the computing system to insert the determined cross-domain links into one or more of the databases of the different systems.
